(19) United States
(12) Patent Application Publication
(10) Pub. No.: US 2006/0067178 A1
(43) Pub. Date: Mar. 30, 2006

(54) Optical pickup device

(75) Inventors: Sumito Nishioka, Nara (JP); Nobuo Ogata, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/227,947

(22) Filed: Sep. 14, 2005

(30) Foreign Application Priority Data
Sep. 17, 2004 (JP) 2004-272375

(51) Int. Cl. G11B 7/00

(52) U.S. Cl. 369/44.41; 369/112.01

(57) ABSTRACT

In an optical pickup device of the present invention, return light from an optical disk is diffracted by a diffraction element divided into two or more regions, and while a first light-receiving section receiving plus 1st-order diffracted light having passed through the first region of the diffraction element is provided on one side of an optical axis of a light beam not diffracted by the diffraction element, a second light-receiving section receiving minus 1st-order diffracted light having passed through the second region is provided on the other side of the optical axis. This arrangement makes it possible to easily and surely adjust the optical system of the optical pickup device.

This Nonprovisional application claims priority under 35 U.S.C. § 119(a) on Patent Application No. 2004-272375 filed in Japan on Sep. 17, 2004, the entire contents of which are hereby incorporated by reference.

### FIELD OF THE INVENTION

The present invention relates to an optical pickup device used for recording and/or reproducing information on/from an optical recording medium such as an optical disk.

### BACKGROUND OF THE INVENTION

There has recently been strong demand for the increase in information recording density and information recording capacity of an optical recording medium such as an optical disk, in order to record, for instance, high-quality moving images in the medium. Furthermore, there has also been strong demand for the reduction in size and weight of the optical pickup device, in order to allow the aforesaid optical disk to be played back on a mobile device.

In view of the above, there has been proposed an optical pickup device in which various types of integrations are done in consideration of the demand of size and weight reductions. For example, Patent Document 1 (Japanese Laid-Open Patent Application No. 2-273336/1990 (published on Nov. 7, 1990)) proposes an optical pickup device in which the number of optical components is reduced on account of the use of a diffraction element.

Incidentally, there are two types of optical disks: so-called recordable optical disks, and playback-only optical disks that are different from the recordable optical disks in terms of the structure. In the recordable optical disk, a series of guide grooves are formed in advance on an information recording surface of the disk, and information signals can be recorded or deleted along the guide grooves. On the other hand, in the playback-only optical disk, rows of concave and convex pits corresponding to information signals are formed in advance on the disk, and the optical pickup device can only perform playback based on the information signals read out from the rows of concave and convex pits.

In this kind of environment, it is as a matter of course desirable that a single optical pickup device can unrestrainedly record and/or reproduce information on/from those optical disks having different structures.

However, in general, push-pull, which is for the recordable disks having guide grooves the most suitable method to detect a tracking error signal (hereinafter, TES), is not suitable for the playback-only disks having no guide grooves. On the other hand, three-spot, which is the most typical method of detecting a TES of the playback-only disks, is not applicable to the recordable disks.

For this reason, in order to record and/or reproduce, by a single optical pickup device, information on/from both the recordable disks and playback-only disks, the optical pickup device is required to support different methods of detecting a TES, which correspond to the respective disk structures.

In view of this, Patent Document 2 (Japanese Laid-Open Patent Application No. 10-143878/1998 (published on May 29, 1998)) proposes an optical pickup device capable of unrestrainedly performing recording and/or reproduction on/from plural types of optical disks having different structures. More specifically, a 4-way-split diffraction element is combined with a multi-way-split photo-detector, so that a TES can be detected by either DPD (TES detecting method for playback-only disks) or push-pull (TES detecting method for recordable disks).

In both Patent Documents 1 and 2, however, high-speed operations cannot be performed because an RF signal (recording information signal in Patent Document 2) is detected using a signal generated by adding up signals produced from two or more diffracted lights by means of the diffraction element.

That is to say, in the aforesaid case where the diffracted light by the diffraction element is used for obtaining the RF signal, the diffracted light is influenced by wavelength variation and tolerance. For this reason, the light-receiving section has to be largish in size in consideration of the variation of a point of convergence on the light-receiving element. Such a limitation that the size of the light-receiving section must be large hinders the high-speed playback of the RF signal.

To achieve the high-speed playback of the RF signal, a technique of detecting an RF signal without using diffracted light, i.e. a technique of detecting an RF signal using non-diffracted light, has been developed.

However, in both cases, i.e. both in the case where an RF signal is detected using diffracted light and in the case where an RF signal is detected without using diffracted light, the adjustment of an optical system of an optical pickup device is accompanied by the following problem.

In a conventional optical pickup device, focus offset occurs when, for example, the light-receiving section deviates in the optical axis direction, the objective lens is close to the optical disk, or the objective lens is far from the optical disk. The focus offset indicates that a focus error signal (hereinafter, FES) is 0 at a point away from the just-focus position, i.e. at a point away from the point of convergence. It is therefore necessary to adjust the optical system in order to prevent the focus offset from occurring.

In conventional arrangements, the optical system is adjusted by moving the light-receiving section in the optical axis direction.

However, the adjustment of the optical system by moving the light-receiving section in the optical axis direction cannot be easily done on account of problems such as spatial limitation. It has therefore been difficult to perform the adjustment accurately.

### SUMMARY OF THE INVENTION

In consideration of the above-identified problem, the present invention aims at providing an optical pickup device having an easily-adjustable optical system.

To achieve the objective, the optical pickup device of the present invention comprises: an objective lens that causes a light beam emitted from a light source to converge on an optical recording medium; a diffraction element that diffracts light reflected on the optical recording medium and that is divided into two or more regions; and a light-receiving element that receives a light beam diffracted by the diffraction element, the light-receiving element including: first light-receiving means that is provided so as to receive plus 1st-order diffraction light passing through a first region of said two or more regions; and second light-receiving means that is provided so as to receive minus 1st-order diffraction light passing through a second region of said two or more regions, each of the first light-receiving means and the second light-receiving means having divided regions, and the first light-receiving means and the second light-receiving means being provided on different sides of a light beam that is not diffracted by the diffraction element.

As described above, in conventional arrangements, focus offset occurs when, for instance, light-receiving means in an optical pickup device deviates in the optical axis direction. To eliminate the focus offset, the adjustment is performed by moving the light-receiving means in the optical axis direction. Such an adjustment of the light-receiving means is burdensome and cannot be accurately performed.

In view of the above, the inventors of the present application hit on an idea of eliminating the focus offset without moving the light-receiving means in the optical axis direction.

Based on this idea, as described above, the present invention is arranged in such a manner that the diffraction light passing through the diffraction element is separated into plus 1st-order diffracted light and minus 1st-order diffracted light by the first and second regions of the light-receiving element. Furthermore, these plus 1st-order diffracted light and minus 1st-order diffracted light are received by the first light-receiving means and the second light-receiving means, respectively, these first and second light-receiving means are provided on different sides of the optical axis of the light beam which is not diffracted by the diffraction element.

It is possible, for instance, the light-receiving means each receiving a diffracted light beam may be provided on the same side of the optical axis of the optical beam which is not diffracted by the diffraction element. In this case, however, the adjustment of the focus offset cannot be done by rotating the diffraction element.

That is, in the present invention, light is diffracted after being separated into plus 1st-order diffracted light and minus 1st-order diffracted light, and received by the first and second light-receiving means, respectively. With this, when the position of the spot of the first diffracted light on the first light-receiving means rises in response to the rotation of the light-receiving element, the position of the spot of the second diffracted light on the second light-receiving means falls. On the other hand, when the position of the spot of the first diffracted light on the first light-receiving means falls, the position of the spot of the second diffracted light on the second light-receiving element rises.

In this manner, causing the position of the spot to rise or fall by a certain degree of rotation of the light-receiving element makes it possible to find a position where both the plus 1st-order diffracted light and the minus 1st-order diffracted light equally irradiate divided regions on the light-receiving means.

The focus offset does not occur when the light irradiations are equal as above. On this account, it is possible to provide the optical pickup device which allows for easy adjustment of the optical system with certainty, only by rotating the diffraction element.

It is noted that, in the specification, sets of diffracted light diffracted by the diffraction element are termed plus 1st-order diffracted light and minus 1st-order diffracted light. These terms are used only for descriptive purposes, in order to differentiate the sets of diffracted light, which are diffracted on different sides of the non-diffracted light, from each other.

For a fuller understanding of the other purpose, nature, and advantages of the invention, reference should be made to the ensuing detailed description taken in conjunction with the accompanying drawings.

### BRIEF DESCRIPTION OF THE DRAWINGS

FIGS. 1(a) and 1(b) show an optical pickup device of an embodiment of the present invention. FIG. 1(a) schematically illustrates (i) a diffraction element in a state of focus offset, (ii) the directions of diffracted light beams and a non-diffracted light beam, and (iii) light-receiving patterns and an arrangement of a light-receiving element. FIG. 1(b) schematically shows (i) the diffraction element in such a state that the focus offset adjustment is performed by rotating the diffraction element of FIG. 1(a), (ii) the directions of diffracted light beams and a non-diffracted light beam, and (iii) light-receiving patterns and an arrangement of the light-receiving element.

FIG. 2 schematically shows the optical pickup device of the embodiment of the present invention.

FIG. 3 schematically illustrates a grating pattern of a diffraction grating of the optical pickup device of the embodiment of the present invention.

FIG. 4 is a schematic diagram of the grating pattern of the diffraction element.

FIG. 5(a) schematically illustrates (i) the aforesaid diffraction element in a state of in-focus, (ii) the directions of diffracted light beams and a non-diffracted light beam, and (iii) light-receiving patterns and an arrangement of a light-receiving element. FIG. 5(b) illustrates (i) the diffraction element in a state of focus offset, (ii) the directions of diffracted light beams and a non-diffracted light beam, and (iii) light-receiving patterns and an arrangement of the light-receiving element.

FIG. 6 is a schematic diagram of an optical pickup device of another embodiment of the present invention.

FIG. 7(a) is a plan view showing a positional relationship between a semiconductor laser and a light-receiving element, in the package of the optical pickup device of FIG. 6. FIG. 7(b) is a profile of an optical integrated unit, showing a channel of a light beam in the optical integrated unit.

FIG. 8 is a schematic view of an optical pickup device of a referential example of the present invention.

FIG. 9 is a profile of an optical integrated unit of the optical pickup device of the referential example of FIG. 8.

FIG. 10(a) relates to the aforesaid referential example and schematically shows (i) a diffraction element in a state of in-focus, (ii) the directions of diffracted light beams and a non-diffracted light beam, and (iii) light-receiving patterns and an arrangement of a light-receiving element. FIG. 10(b) also relates to the aforesaid referential example and schematically shows (i) the diffraction element in a state of focus offset, (ii) the directions of diffracted light beams and a non-diffracted light beam, and (iii) light-receiving patterns and an arrangement of the light-receiving element.

FIG. 11(a) relates to the aforesaid referential example and schematically shows (i) the diffraction element in a state of focus offset, (ii) the directions of diffracted light beams and a non-diffracted light beam, and (iii) light-receiving patterns and an arrangement of the light-receiving element. FIG. 11(b) schematically shows (i) the diffraction element in such a state that the focus offset adjustment is performed by rotating the diffraction element of FIG. 11(a), (ii) the directions of diffracted light beams and a non-diffracted light beam, and (iii) light-receiving patterns and an arrangement of the light-receiving element.

### DESCRIPTION OF THE EMBODIMENTS

### REFERENTIAL EXAMPLE

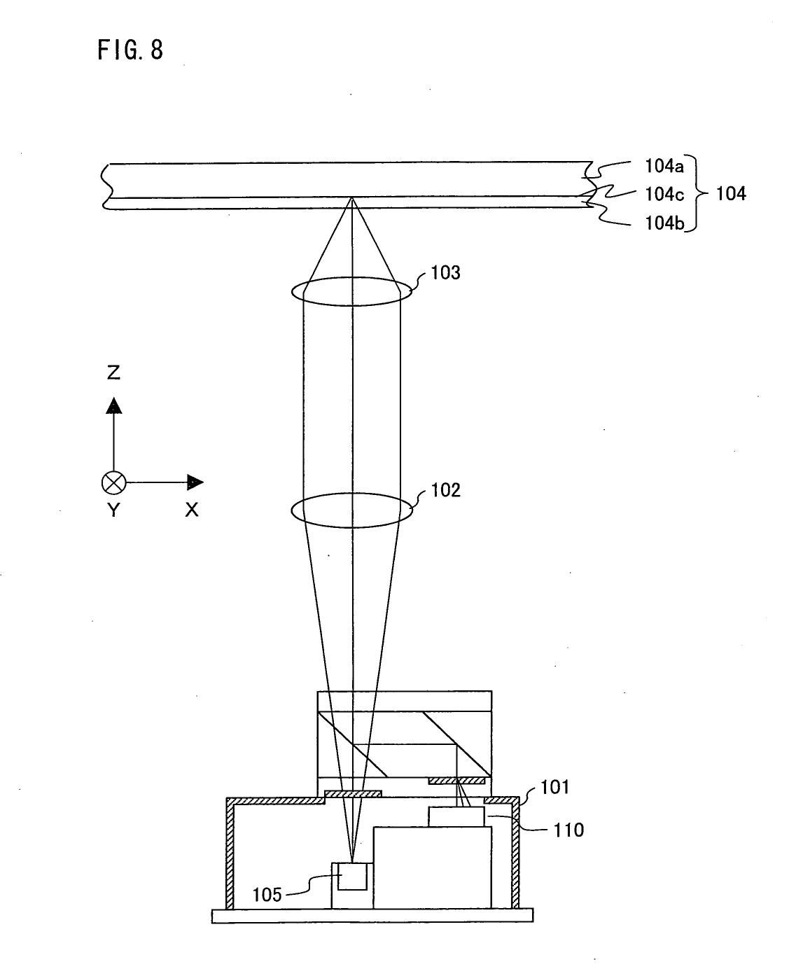

Before explaining an embodiment, a referential example of the embodiment will be discussed with reference to FIGS. 8 to 11(a) and 11(b), along with the problems of the referential example. Note that the referential example relates to an optical pickup device that can obtain an RF signal without using diffracted light.

As shown in FIG. 8, the optical pickup device of the referential example of the present embodiment includes an optical integrated unit 101, collimator lens 102, and objective lens 103.

In the optical pickup device, light emitted from a semiconductor laser 105 mounted on the optical integrated unit 101 is converted to parallel light by the collimator lens 102, and then converges on an optical disk 104 by the objective lens 103. The return light reflected on the optical disk 104 passes through the objective lens 103 and the collimator lens 102 again, so as to converge on a light-receiving element 110 mounted on the optical integrated unit 101. The optical disk 104 comprises a substrate 104a, a cover layer 104b through which the light beam passes, and a recording layer 104c used for recording and/or reproducing information.

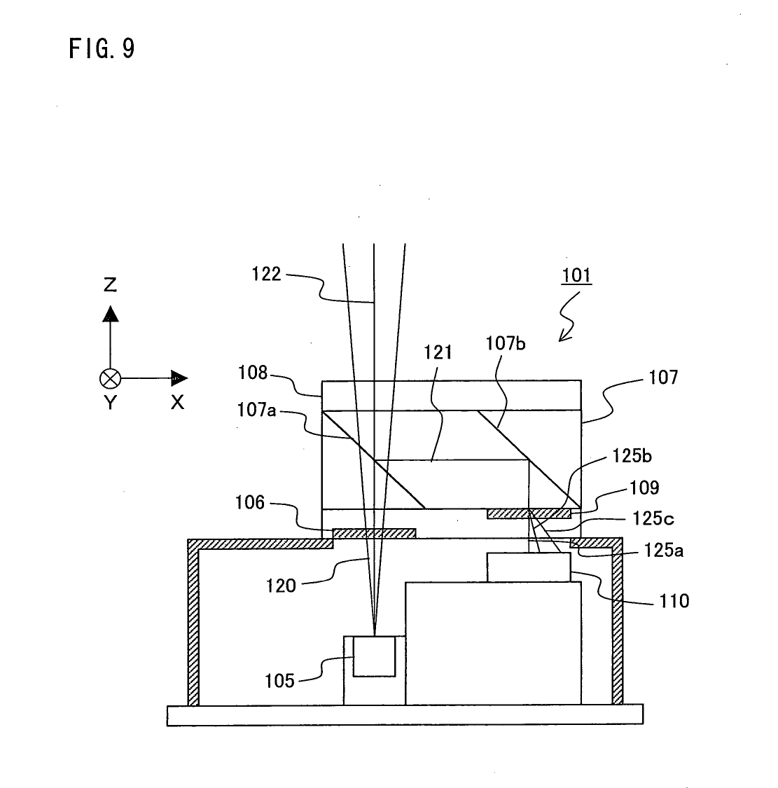

As shown in FIG. 9, in the optical integrated unit 101, light 120 having an optical axis 122 is emitted from the semiconductor laser 105 as a light source, and this light 120 is split, by a three-beam diffraction grating 106, into a main beam and two sub beams. These beams pass through a polarized light beam splitter (hereinafter, PBS) surface 107a of a composite prism 107, and then pass through a ¼ wavelength plate 108. Subsequently, the beams head for the collimator lens 102 shown in FIG. 8. Note that ±1st-order diffracted lights are not illustrated in order to simplify the figure.

The return light 121 from the optical disk 104 passes through the ¼ wavelength plate 108 and reflected on the PBS surface 107a and a reflecting mirror surface 107b, and consequently enters a diffraction element 109. The return light 121 having entered the diffraction element 109 is separated into zeroth-order diffracted light with an optical axis 125a and sets of plus 1st-order light with optical axes 125a and 125c, and enter a light-receiving element 110. As to the return light 121, only the light beams with the optical axes 125a, 125b, and 125c are illustrated for the sake of simplicity.

The light emitted from the semiconductor laser 105 is linearly-polarized light whose polarization direction is in parallel to an X direction, i.e. the light is P-polarized light. Such light is converted to circularly-polarized light by the ¼ wavelength plate 108, after passing through the PBS surface 107a. The light then enters the optical disk 104. The return light 121 from the optical disk 104 again enters the ¼ wavelength plate 108 so as to be converted to linearly-polarized light in parallel to a Y direction, i.e. converted to S-polarized light. This S-polarized light is reflected on the PBS surface 107a.

In this manner, almost all of the main beam and sub beams of the light emitted from the semiconductor laser 105 is led to the optical disk 104. Also, almost all of the return light 121 is led to the light-receiving element 110. The use of light is therefore highly efficient.

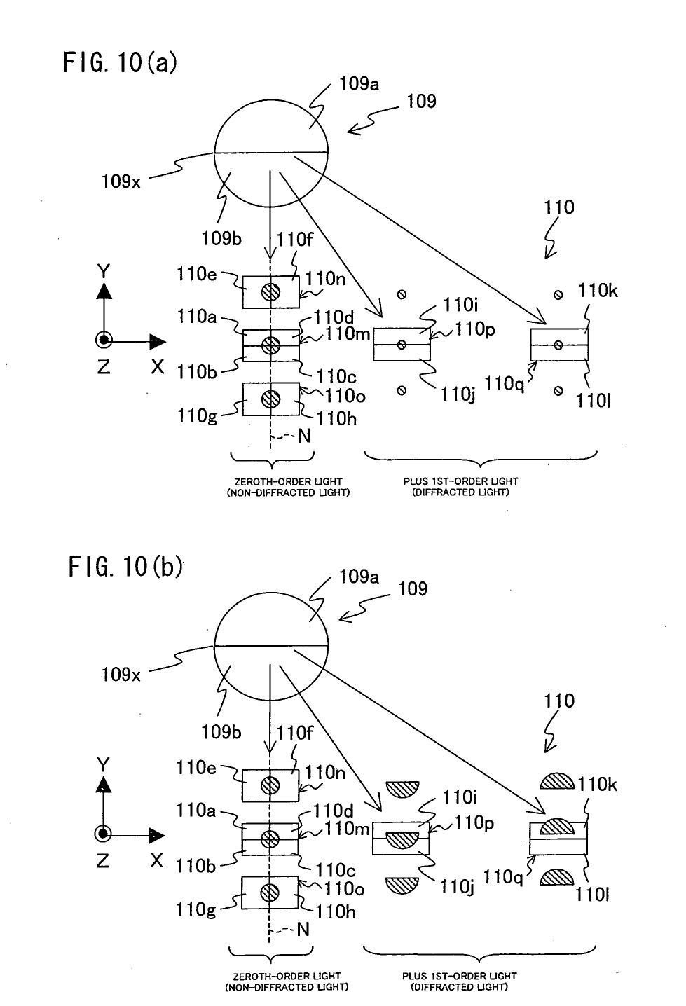

Referring to FIGS. 10(a) and 10(b), a grating pattern of the diffraction element 109 and patterns of light-receiving sections 110m to 110q of the light-receiving element 110 are described.

As shown in FIGS. 10(a) and 10(b), the diffracting element 109 is divided into two regions 109a and 109b, by a dividing line 109x running in the direction orthogonal to the tracks of the optical disk 104, i.e. in the X direction corresponding to the tracking direction.

The light-receiving element 110 includes: three light-receiving sections 110m to 110o that detect zeroth-order diffracted light from the diffraction element 109; a light-receiving section 110p that detects plus 1st-order diffracted light passing through one region 109a of the diffraction element 109; and a light-receiving section 110q that detects plus 1st-order diffracting light passing through the other region 109b of the diffraction element 109.

In practice, the center of the diffraction element 109 corresponds to the center of the light-receiving section 110m. However, the center of the diffraction element 109 in the figures is moved in the Y direction, in order to clarify the description.

The light-receiving element 110 detects a focus error signal (hereinafter, FES) by double knife edge method using output signals from the divided regions 110i to 110l of two light-receiving sections 110p and 110q to which the plus 1st-order diffracted light enters. Also, the light-receiving element 110 detects (i) an RF signal by output signals from the divided regions 110i to 110l of two light-receiving sections 110p and 110q to which zeroth-order diffracted light enters, and (ii) a tracking error signal (hereinafter, TES) by phase difference (DPD) by the output signals from the divided regions 110i to 110l. Furthermore, the light-receiving element 110 detects a TES by differential push-pull (hereinafter, DPP) using output signals from divided regions 110a to 110h of three light-receiving sections 110m to 110o to which zeroth-order diffracted light enters.

In the above-described optical pickup device, however, the deviation of the light-receiving section in the optical axis direction causes the plus 1st-order diffracted light to widen as shown in FIG. 10(b), so that focus offset occurs. To prevent the focus offset from occurring, it is necessary to rotate and adjust the diffraction element 109. More specifically, provided that the outputs from the divided regions 110i to 110l are Si to Sl, respectively, the diffraction element 109 is rotated for the adjustment, in such a way as to meet Si=Sj and Sk=Sl.

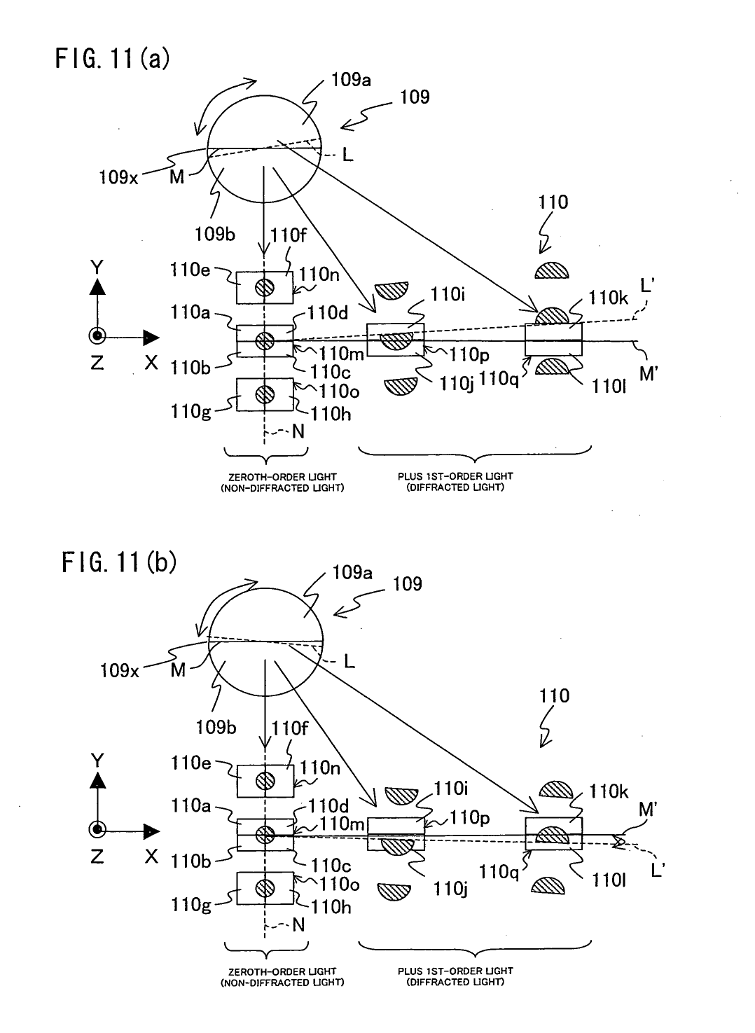

However, in a case where the diffraction element 109 is rotated to meet Si=Sj as shown in FIG. 11(a), i.e. in a case where the diffraction element 109 is rotated in such a manner that a dotted line L in the diffraction element 109 overlaps a full line M, the relationship between the plus 1st-order diffracted light and the light-receiving section changes from a dotted line L′ to a full line M′. In this case, Sk≠Sl.

On the other hand, when the adjustment by the rotation is done in such a manner as to meet Sk=Sl as shown in FIG. 11(b), i.e. when the diffraction element is rotated in such a manner that a dotted line L in the diffraction element 109 overlaps a full line M, the relationship between the plus 1st-order diffracted light and the light-receiving section changes from a dotted line L′ to a full line M′. In this case, Si≠Sj.

Si=Sj and Sk=Sl are not met in both cases, resulting in a problem that the focus offset cannot be adjusted.

This is because, since two sets of plus 1st-order diffracted light are on the same side of the zeroth-order diffracted light, one of two spots of the two sets of plus 1st-order diffracted light falls in response to the rise of the other spot on account of the rotation of the diffraction element 109, and vice versa. This problem was solved by the inventors of the present invention, in the manner described below.

### Embodiment 1

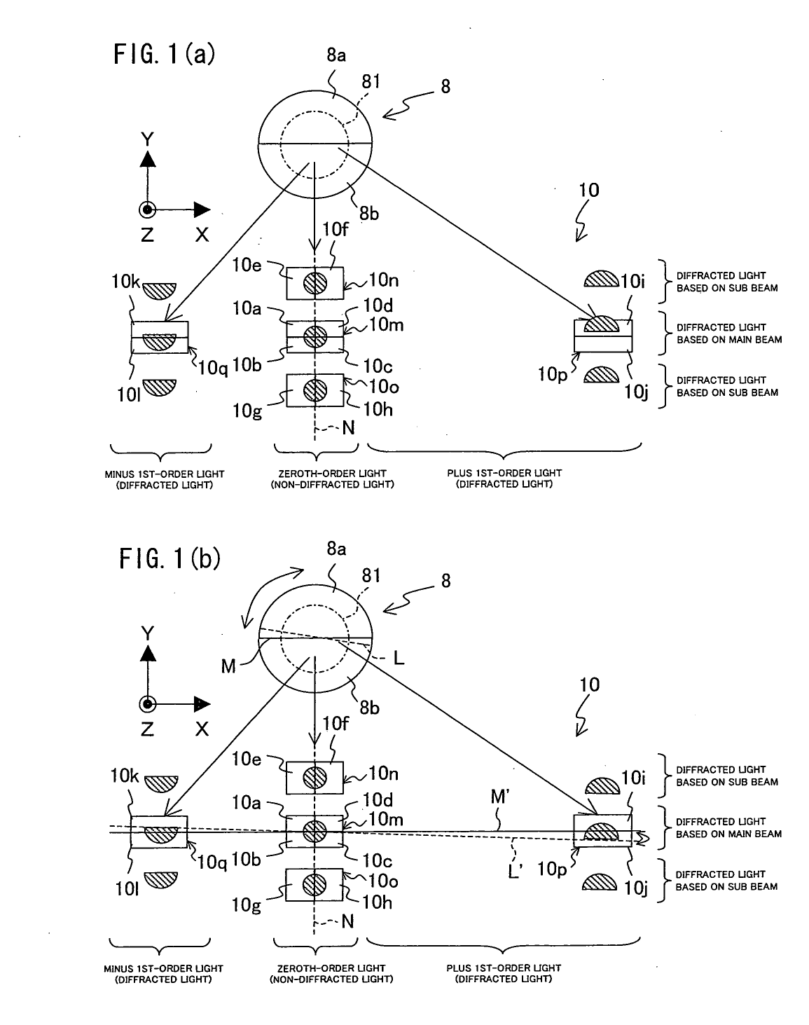

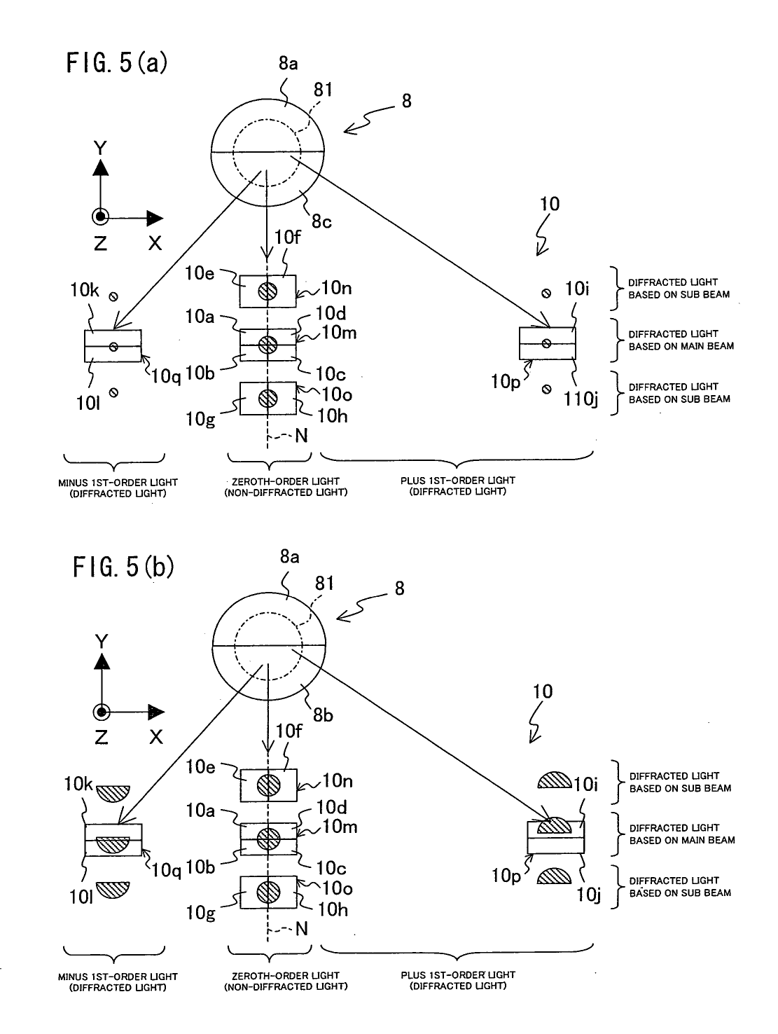

The following will describe an embodiment of the present invention in reference to FIGS. 1(a), 1(b), 5(a), and 5(b).

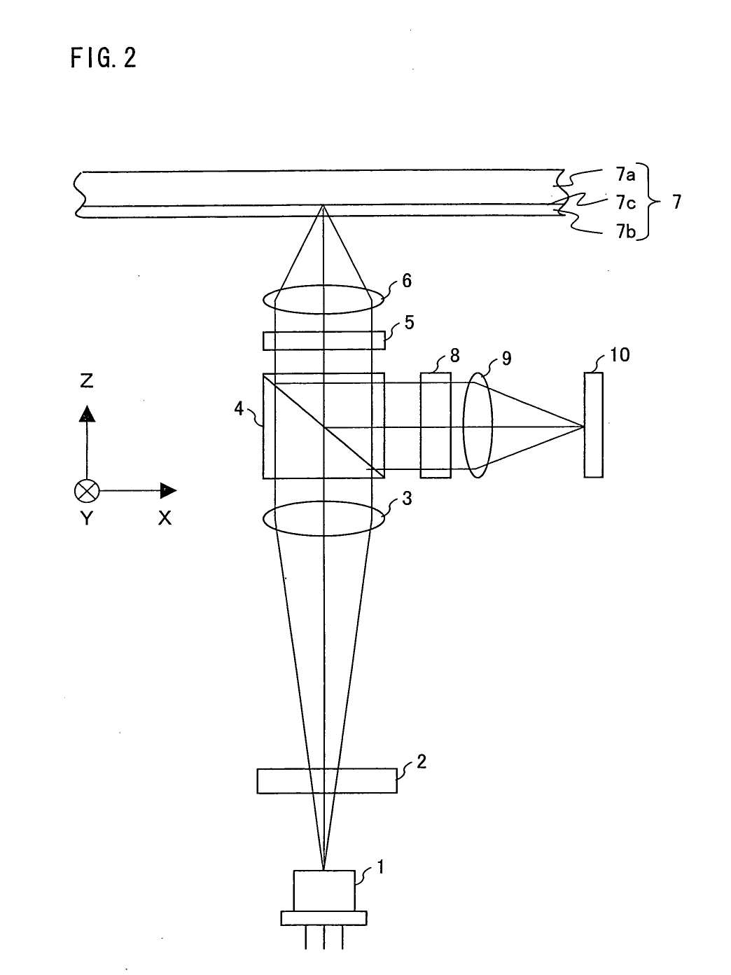

As shown in FIG. 2, an optical pickup device of the present embodiment includes a semiconductor laser 1 as a light source, a diffraction grating 2, a collimator lens 3, a PBS 4, a ¼ wavelength plate 5, an objective lens 6, a diffraction element 8, a detection lens 9, and a light-receiving element 10.

In the optical pickup device thus arranged, a light beam emitted from the semiconductor laser 1 passes through the diffraction grating 2 on which a diffraction pattern for generating three beams is formed, and the light beam is then converted to parallel light by the collimator lens 3. Subsequently, the light beam passes through the PBS 4 and the ¼ wavelength plate 5, converges, via the objective lens 6, on the optical disk 7 serving as an optical recording medium, and the light is then reflected on the optical disk 7. The light beam (return light) reflected on the optical disk 7 again passes through the objective lens 6 and the ¼ wavelength plate 5. After the light path is bended by the PBS 4, the light beam passes through the diffraction element 8 and detection lens 9 and enters the light-receiving element 10.

The optical disk 7 comprises a substrate 7a, a cover layer 7b through which the light beam passes, and a recording layer 7c formed at the border between the substrate 7a and the cover layer 7b. The objective lens 6 is driven by an objective lens drive mechanism (not shown), so as to move (i) in the focusing direction, i.e. in the Z direction in FIG. 2, and (ii) in the tracking direction, i.e. in the X direction in FIG. 2. With this, a spot of light convergence follows a predetermined point on the recording layer 7c, even if the surface of the optical disk 7 fluctuates or the center of the optical disk 7 is deviated.

In the present embodiment, the semiconductor laser 1 is provided with a short-wavelength light source whose wavelength is about 405 nm, and the objective lens 6 which is a high-NA objective lens whose NA is about 0.85, and hence high-density recording and playback are realized. When the short-wavelength light source and the high-NA objective lens are adopted as above, a high degree of spherical aberration occurs on account of an error in the thickness of the cover layer 7b of the optical disk 7.

To correct the spherical aberration on account of the error in the thickness of the cover layer 7b, either a position of the collimator lens 3 is adjusted in the optical axis direction by means of a collimator lens drive mechanism (not illustrated), or a gap in a beam expander (not illustrated), which is made up of two lenses and provided between the collimator lens 3 and the objective lens 6, is adjusted by means of a beam expander drive mechanism (not illustrated).

On the diffraction grating 2, a diffraction pattern for generating three beams (main beam and two sub beams) is formed in order to detect a TES. Examples of TES detection methods using three beams include a three-beam method, DPP, and phase-shift DPP.

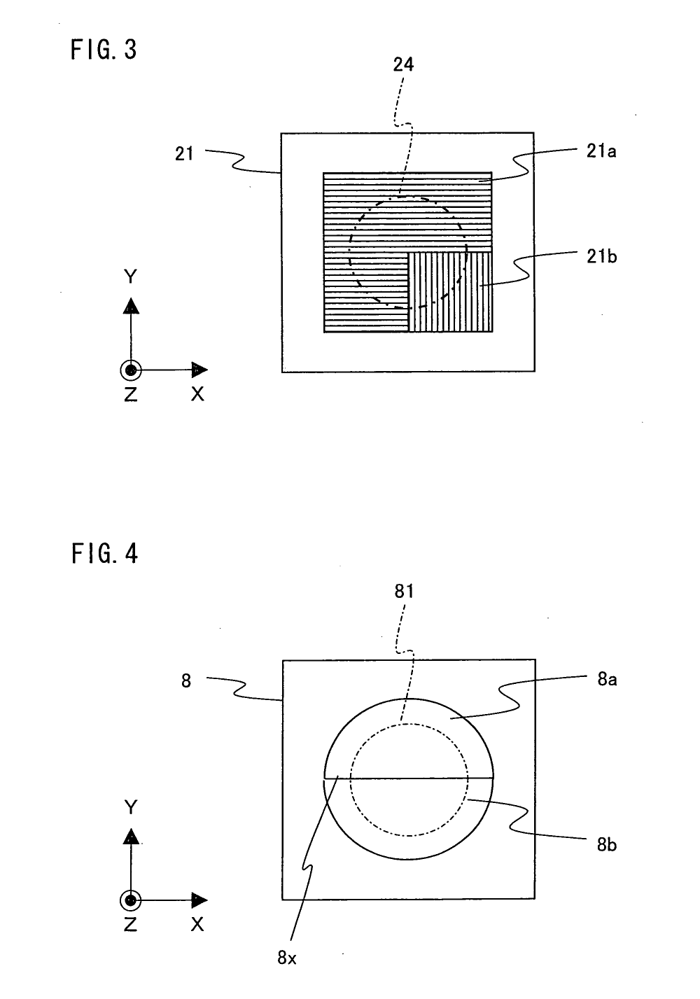

Now, the grating pattern formed on the diffraction grating 2 will be described in reference to FIG. 3. Note that the grating pitch of the diffraction grating 2 is designed in such a way as to keep the three beams on the light-receiving element 10 to be sufficiently distanced from each other. In FIG. 3, a dashed line indicates a light beam 24 entering the diffraction grating 2.

In the present embodiment, the grating pitch of the diffraction grating 2 is about 11 μm, the distance between the semiconductor laser 1 and the diffraction grating 2 is about 5 mm in terms of a light path length in the air, the distance between the main beam and each sub beam is about 150 μm on the light-receiving element 10, and the distance between the main beam and each sub beam is about 16 μm on the optical disk 7. These numeric values, however, are non-limiting examples.

The grating pattern of the diffraction grating 2 may be an orderly linear grating, adopting three-beam method or DPP for detecting a TES. However, described below is a grating pattern adopting a phase-shift DPP, which is disclosed in Patent Document 3 (Japanese Laid-Open Patent Application No. 2001-250250 (published on Sep. 14, 2001)).

As shown in FIG. 3, the grating pattern of the diffraction grating 2 of the present embodiment has two regions 21a and 21b. Phases of periodic structures of these regions 21a and 21b are different from each other for 180°. With these periodic structures, a push-pull signal amplitude of the sub beams is substantially 0, making it possible to cancel the offset at the time of the shifting of the objective lens or the tilting of the disk. The more the light beam 24 on the diffraction grating 2 is precisely aligned with the regions 21a and 21b, the more the cancellation of the offset is properly performed.

Also, elongating the effective diameter of the light beam 24 reduces the adverse effect of the misalignment of the light beam 24 and the regions 21a and 21b. Such misalignment occurs on account of change over time and change in temperature. In other words, elongating the effective diameter reduces the adverse effect on a servo signal which is detected in a later stage.

For example, in an optical system in which an effective NA of the collimator lens 3 is about 0.1, the distance between the semiconductor laser 1 and the diffraction grating 2 is about 5 mm in terms of a light path length in the air, and the effective diameter of the light beam on the diffraction grating 2 is about φ1 mm. In this manner, the effective diameter of the diffraction grating 2 can be increased to be 2.5 to 5 times longer than the effective diameter, which is φ0.2 mm to 0.4 mm, of the light beam of a conventional diffraction grating 2.

As shown in FIG. 4, the grating pattern formed on the diffraction element 8 is divided into a first region 8a and a second region 8b. More specifically, the diffraction element 8 is composed of a semicircular first region 8a and a semicircular second region 8b, which are divided by a border line 8x running in the X direction corresponding to a direction orthogonal to the direction along the tracks of the optical disk 7.

In the figure, a dashed line indicates the return light 81 of the main beam that was not diffracted by the diffraction grating 2 in FIG. 2. Also, FIG. 4 does not illustrate the sets of return light corresponding to two sub beams diffracted by the diffraction grating 2 in FIG. 2. Note that, although the diffraction element 8 is divided in two by a straight line corresponding to the diameter of the diffraction element 8. However, the regions as a result of the division are not necessarily arranged as above, and the number of division is not necessarily two.

The grating pitch in the first region 8a of the diffraction element 8 is long (i.e. the diffraction angle is minimum), while the grating pitch in the second region 8b of the diffraction element 8 is short (i.e. the diffraction angle is maximum). Not limited to this, the grating pitch may be long in the second region 8b of the diffraction element 8 while short in the first region 8a.

With the arrangement above, a first light-receiving section 10p that detects a light beam (sub beam) passing through the first region 8a and diffracted in plus 1st order, and a second light-receiving section 10q that detects a light beam (sub beam) passing through the second region 8b and diffracted in minus 1st order, are so positioned as not to be equidistant from the optical axis N.

On this account, unnecessary diffracted light, i.e. the light beam diffracted in −1st order in the first region 8a, does not enter the second light-receiving section 10q. Also, the light beam diffracted in plus 1st order in the second region 8b does not enter the first light-receiving section 10p.

As described above, differentiating the grating pitch in the first region 8a from the grating pitch in the second region 8b prevents unnecessary diffracted light (sub beam) emitted from the diffraction element 8 from entering the first light-receiving section 10p and/or the second light-receiving section 10q. This makes it possible to steadily perform the adjustment of the focus offset by the rotation around the optical axis N.

As discussed later, the FES signal utilized for correcting the focus offset is detected by the double knife edge method using the plus 1st-order diffracted light from the first region 8a and the minus 1st-order diffracted light from the second region 8b. Alternatively, the FES signal may be detected by the double knife edge method using the minus 1st-order diffracted light from the first region 8a and the plus 1st-order diffracted light from the second region 8b.

It is noted that a method of working out the FES signal using either the plus 1st-order diffracted light or the minus 1st-order diffracted light is the single knife edge method, while a method of working out the FES signal using both the plus 1st-order diffracted light and the minus 1st-order diffracted light is the double knife edge method.

Now, referring to FIGS. 5(a) and 5(b), the following will describe the relationship of (i) the grating pattern, which is divided in two, of the diffraction element 8, (ii) the directions of the light beams diffracted by the diffraction element 8, and (iii) light-receiving patterns and an arrangement of the light-receiving element 10.

In order to prevent spherical aberration, which is caused due to the thickness of the cover layer 7b of the optical disk 7, from occurring on the beam converged by the objective lens 6, a position of the collimator lens 3 is adjusted in the optical axis direction so that the light focuses on the recording layer 7c. FIG. 5(a) shows such a state that light beams irradiate the divided regions 10a-10l while the light focuses on the recording layer 7c.

FIG. 5(a) further illustrates the relationship between two regions 8a and 8b of the diffraction element 8 described in FIG. 4 and the traveling directions of the zeroth-order diffracted light and the ±1st-order diffracted lights. In practice, the center of the diffraction element 8 is positioned so as to correspond to the center of the third light-receiving section 10m. However, the center of the diffraction element 8 in the figure is moved in the Y direction with respect to the optical axis direction corresponding to the Z direction in FIG. 5(a), in order to clarify the description.

As shown in FIG. 5(a), the light-receiving element 10 is composed of five light-receiving sections 10m-10q. In the outgoing optical system, three light beams (main beam and two sub beams) formed by the diffraction grating 2 are reflected on the optical disk 7. In the return optical system, the return light is further separated by the diffraction element 8 into the zeroth-order diffracted light and ±1st-order diffracted lights.

The light-receiving element 10 is provided with the light-receiving sections 10m-10q and their divided regions 10a-10l, in order to receive those light beams which are necessary for detecting an RF signal and a servo signal, among the zeroth-order diffracted light and ±1st-order diffracted lights.

Specifically, from two sub beams and one main beam, the diffraction element 8 generates nine beams: three beams of zeroth-order diffracted light; three beams of plus 1st-order diffracted light; and three beams of minus 1st-order diffracted light. The light-receiving sections that receive the zeroth-order diffracted light are the third light-receiving sections 10m-10o. The light-receiving section that receives the plus 1st-order diffracted light is the first light-receiving section 10p. The light-receiving section that receives the minus 1st-order diffracted light is the second light-receiving section 10q.

The beam of the zeroth-order diffracted light is arranged so that the diameter thereof is not shorter than a certain length, in order to allow for the TES detection by the push-pull method. In the present embodiment, the light-receiving element 10 is positioned a little bit inward as compared to the focal point of the zeroth-order diffracted light, in order to keep the diameter of the light beam of the zeroth-order diffracted light to be not shorter than a certain length. Not being limited to this arrangement, the light-receiving element 10 may be positioned a little bit outward as compared to the focal point of the zeroth-order diffracted light.

In this manner, the light beam having a certain length of diameter converges at the border section between the divided regions 10a and 10b and the divided regions 10c and 10d of the third light-receiving section 10m. For this reason, the positions of the zeroth-order diffracted light and the light-receiving element 10 can be adjusted by causing the outputs from those four divided regions 10a-10d of the third light-receiving section 10m to be identical with each other.

FIG. 5(b) shows the light beams on the light-receiving element 10, in a case where the objective lens 6 is close to the optical disk 7 as compared to the arrangement shown in FIG. 5(a). Note that, even if the light beam of non-diffracted light is widened as the objective lens 6 approaches the optical disk 7, the light beam does not go beyond the bounds of the divided regions 10a-10d, i.e. the third light-receiving section 10m.

In this manner, when the objective lens 6 is close to the optical disk 7, neither Sk=Sl nor Si=Sl is met as shown in FIG. 5(b), so that the focus offset occurs. On this account, since the FES is 0 at a position deviated from the just focus position, it is necessary to adjust the optical system including members such as the diffraction element 8 and the light-receiving element 10, in order to prevent the misalignment. Also, in a case where the objective lens 6 is far from the optical disk 7, the focus offset occurs in a similar manner. Also in this case, the optical system is required to be adjusted as above.

An operation of generating a focus servo signal will be described in reference to FIGS. 4, 5(a), and 5(b). In the description, the output signals from the divided regions 10a-10l of the light-receiving sections 10m-10q are termed Sa-Sl, respectively.

An RF signal (hereinafter a value of the RF signal will be referred to as RF) is detected using the zeroth-order diffracted light. RF is figured out by the following equation.
RF=Sa+Sb+Sc+Sd

In this manner, detecting the RF signal by the zeroth-order diffracted light makes it possible to speedily figure out the RF signal, as compared to the case where the RF signal is detected using a signal generated by adding up two or more signals by means of the diffraction element 8.

According to the DPD, a TES 1 is detected by comparing phases of Sa-Sd, i.e. by figuring out the difference between the phase of (Sa+Sc) and the phase of (Sb+Sd).

According to the phase-shift DPP, a TES 2 is detected by the following equation.
TES2={(Sa+Sb)−(Sc+Sd)}−α{(Se−Sf)+(Sg−Sh)}

In the equation, α is a coefficient optimal for canceling the offset on account of the shifting of the objective lens or the tilting of the disk.

An FES as a focus servo signal is detected using the double knife edge method. More specifically, the FES is figured out as follows.
FES=(Si−Sj)−(Sk−Sl)

Not limited to the double knife edge method, the FES as the focus servo signal may be detected using methods such as the single knife method.

Referring to FIGS. 1(a), 1(b), 4, 5(a), and 5(b), described below is the method of adjusting the positions of the diffraction element 8 and the light-receiving element 10.

As described above, the light beam of the zeroth-order diffracted light, which has a certain length of diameter, converges at the border section between the divided regions 10a-10d of the third light-receiving section 10m. It is therefore possible to adjust the positions of the zeroth-order diffracted light and the light-receiving element 10 in the X and Y directions, by adjusting the third light-receiving section 10m in such a way that the outputs from those four divided regions 10a-10d are equal to each other.

Also, for instance, in a case where, because of reasons such as a fabrication error, the light-receiving sections of the light-receiving element 10 deviate in the optical axis direction, the focus offset occurs as shown in FIG. 1(a). That is, in the case of FIG. 1(a), the focus offset occurs when neither Sk=Sl nor Si+Sj is met.

The focus offset as above has conventionally been adjusted by moving the diffraction element 8 or the light-receiving element 10 in the optical axis direction. However, when the adjustment is carried out by moving the element in the optical axis direction, one cannot easily achieve precise focus offset adjustment on account of reasons such as a spatial limitation.

Furthermore, in a case where, as in the referential example, the light-receiving sections 110p and 110q, which are on the same side with respect to the optical axis of the zeroth-order diffracted light, receive the plus 1st-order light, it is hard to rotate and adjust the light-receiving element, which is a precise and easy measure for adjustment, on account of reasons such as a spatial limitation.

In the present embodiment, as described above, the diffraction element 8 which is divided into the first region 8a and the second region 8b separates the return light into the zeroth-order diffracted light and the ±1st-order diffracted lights, and two light-receiving sections (10p and 10q) receiving the ±1st-order diffracted lights are provided on the different sides of the optical axis N of the zeroth-order diffracted light.

In this arrangement, as shown in FIG. 1(b), when the diffraction element 8 is rotated in such a manner that a dotted line L in the diffraction element 8 overlaps a full line M, the relationship between the ±1st-order diffracted lights and the light-receiving sections changes from a dotted line L′ to a full line M′. Since Si=Sj and Sk=Sl are met in this case, the adjustment to prevent the focus offset from occurring is achieved.

That is to say, for instance, when the diffraction grating 2 shown in FIG. 1(a) rotates in a clockwise direction (indicated by an arrow in the figure), the plus 1st-order diffracted light moves downward (−Y direction) while the minus 1st-order diffracted light moves upward (+Y direction). In short, the plus 1st-order diffracted light and the minus 1st-order diffracted light move in opposite directions.

On this account, Sk=Sl and Si=Sj are met by rotating the diffraction element 8 by a rotation drive section (not illustrated), and hence the occurrence of the focus offset can be prevented only by rotating the diffraction element 8. This eliminates the necessity of the adjustment of the light-receiving element 10 in the Z direction, thereby lessening the burden of the adjustment.

In this manner, using both the plus 1st-order diffracted light and the minus 1st-order diffracted light that are positioned opposite to each other with respect to the zeroth-order diffracted light, it is possible to precisely carry out, by rotating the diffraction element 8 around the optical axis, the adjustment of the focus offset of the FES signal detected by the double knife edge method.

In the description above, three beams are generated by the diffraction grating 2. Alternatively, it is possible to adopt a single-beam optical integrated unit, which does not require three beams for generating a TES. That is, in the present embodiment, while it is necessary in the return optical system to diffract the light reflected on the optical disk 7 into three beams, it is not necessary in the outgoing optical system to diffract the light heading for the optical disk 7 into three beams.

### Embodiment 2

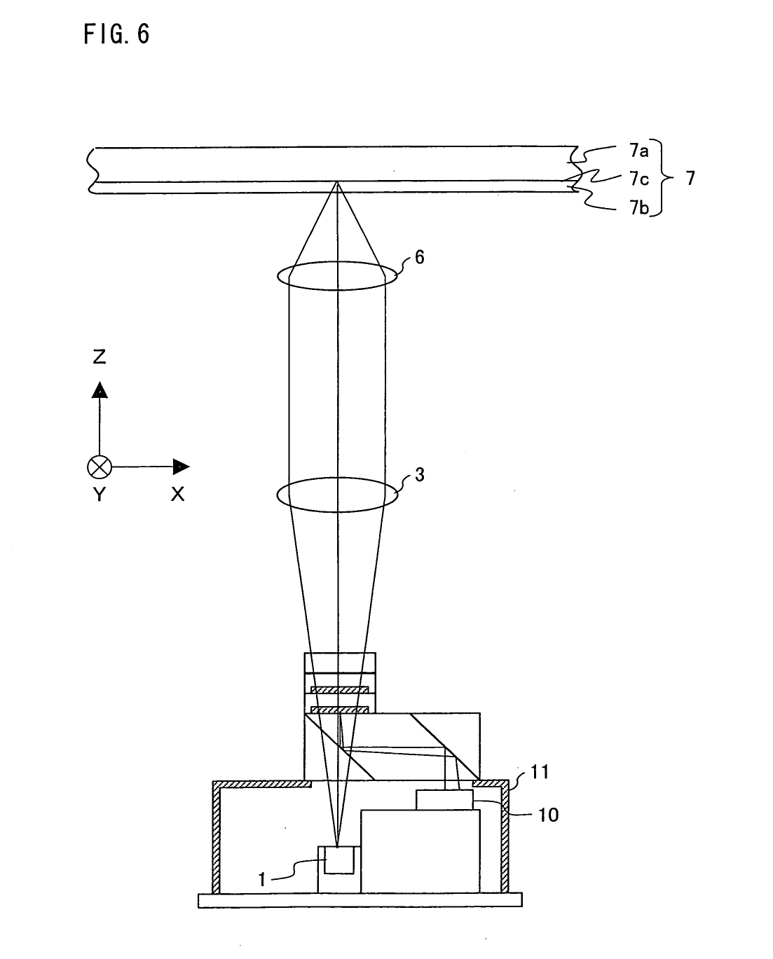

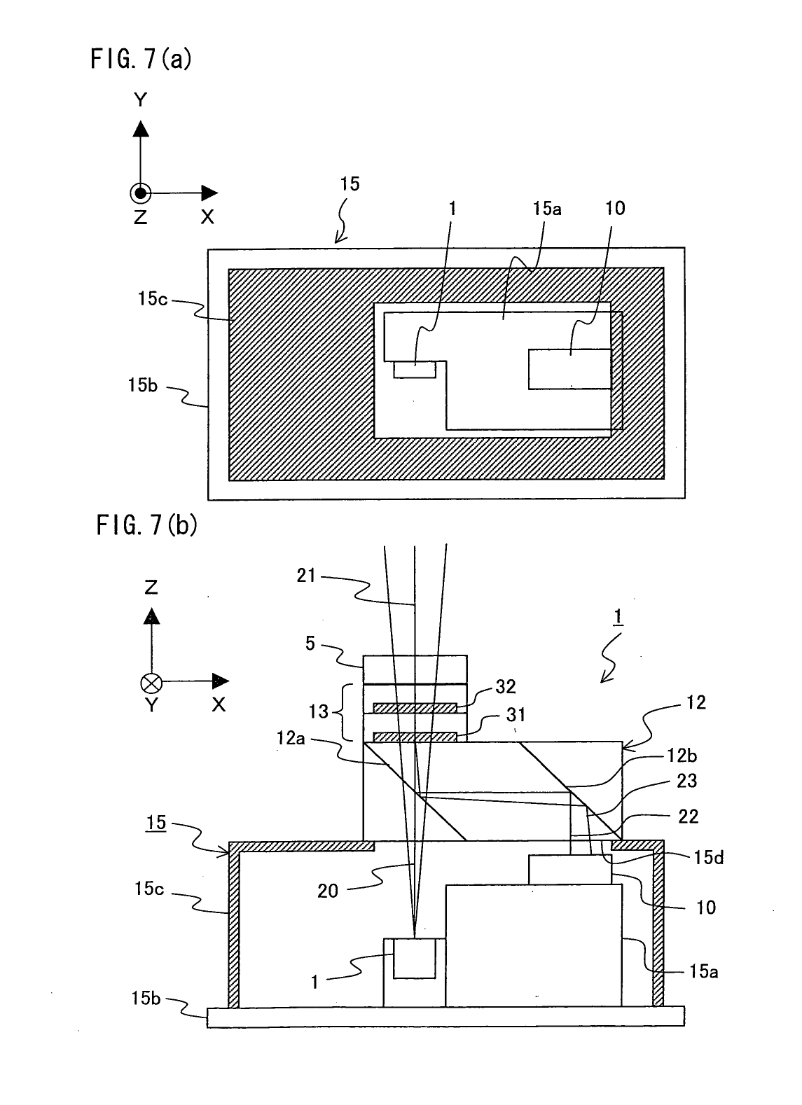

A further embodiment of the present invention will be described in reference to FIGS. 6, 7(a), and 7(b). Since discussed in this embodiment is differences over Embodiment 1, members having the same functions as those described in Embodiment 1 are given the same numbers, so that the descriptions are omitted for the sake of convenience.

Embodiment 2 describes an optical pickup device in which optical devices such as the diffracting grating, diffraction element, and light-receiving sections are positioned differently as compared to those in Embodiment 1.

As shown in FIG. 6, the optical pickup device of the present embodiment includes an optical integrated unit 11, a collimator lens 3, and an objective lens 6.

In this optical pickup device, a light beam emitted from a semiconductor laser 1 serving as a light source mounted on the optical integrated unit 11 is converted into parallel light by the collimator lens 3, and then converges on the optical disk 7 after passing through the objective lens 6. The return light passes through the objective lens 6 and the collimator lens 3 again, and is received by a light-receiving element 10 mounted on the optical integrated unit 11.

Referring to FIGS. 7(a) and 7(b), the structure of the optical integrated unit 11 is described.

The optical integrated unit 11 includes, as shown in FIG. 7(b), a semiconductor laser 1, a light-receiving element 10, a PBS 12, a polarized-light diffraction element 13, a ¼ wavelength plate 5, and a package 15. It is noted that FIG. 7(a) does not illustrate the PBS 12, polarized-light diffraction element 13, and ¼ wavelength plate 5, in order to simplify the figure.

The semiconductor laser 1 has, for instance, an wavelength λ of 405 nm. The light beam with an optical axis 20 is emitted as P-polarized (linearly-polarized) light from the semiconductor laser 1. This light beam passes through a PBS surface 12a of the PBS 12, and enters the polarized-light diffraction element 13. The diffraction element 13 includes (i) a first polarized-light diffraction element 31 that diffracts P-polarized light while allows S-polarized light to pass through and (ii) a second polarized light diffraction element 32 that diffracts S-polarized light while allows P-polarized light to pass through.

The P-polarized light beam 21 having passed through the PBS surface 12a is therefore diffracted by the first polarized-light diffraction element 31, and passes through the second polarized-light diffraction element 32. Note that, the first polarized-light diffraction element 31 is identical in terms of structure with the above-described diffraction grating 2, and the second polarized-light diffraction element 32 is identical in terms of structure with the aforesaid diffraction element 8. For this reason the description of these elements 31 and 32 of the polarized-light diffraction element 13 is omitted.

Thereafter, the P-polarized (linearly-polarized) light is converted by the ¼ wavelength plate 5 into circularly-polarized light, and is emitted from the optical integrated unit 11. The return light from the optical disk 7 enters the integrated unit 11, as circularly-polarized light. This circularly polarized light is converted by the ¼ wavelength plate 5 into S-polarized (linearly-polarized) light. Therefore, this light is diffracted by the second polarized-light diffraction element 32, while passes through the first polarized-light diffraction element 31. The return light is reflected on the PBS surface 12a and the reflecting mirror surface 12b of the PBS 12, and separated into zeroth-order diffracted light with an optical axis 22 and 1st-order diffracted light with an optical axis 23. These diffracted lights enter the light-receiving element 10.

The package 15 includes a system 15a on which the semiconductor laser 1 and the light-receiving element 10 are mounted, a base 15b, and a cap 15c. The cap 15c has a window section 15d for allowing light to pass through. The PBS 12 is sufficiently larger than the window section 15d, so that the package 15 is sealed by adhering and fixing the PBS 12 on the cap 15c. As a result, the semiconductor laser 1 and the light-receiving element 10 are not exposed to the outside air, and hence property deterioration is restrained.

Embodiment 2 has described the optical pickup device in which the optical system including the second polarized-light diffraction element 32 and the like is differently arranged as compared to the optical system in Embodiment 1.

Also in Embodiment 2, the second polarized-light diffraction element 32 is divided into two regions, and by these two regions, the return light from the optical disk 7 is separated into zeroth-order diffracted light and ±1st-order diffracted lights. Moreover, two light-receiving sections (10p and 10q) for receiving the ±1st-order diffracted lights are provided on different sides of the optical axis N of the zeroth-order diffracted light.

Therefore, the second polarized-light diffraction element 32 is rotated around the optical axis N, in consideration of the plus 1st-order diffracted light and the minus 1st-order diffracted light, so that the focus offset adjustment of the FES signal detected by the double knife edge method is certainly carried out.

To achieve the objective above, the optical pickup device of the present invention comprises: an objective lens that causes a light beam emitted from a light source to converge on an optical recording medium; a diffraction element that diffracts light reflected on the optical recording medium and that is divided into two or more regions; and a light-receiving element that receives a light beam diffracted by the diffraction element, the light-receiving element including: first light-receiving means that is provided so as to receive plus 1st-order diffraction light passing through a first region of said two or more regions; and second light-receiving means that is provided so as to receive minus 1st-order diffraction light passing through a second region of said two or more regions, each of the first light-receiving means and the second light-receiving means having divided regions, and the first light-receiving means and the second light-receiving means being provided on different sides of a light beam that is not diffracted by the diffraction element.

As described above, in conventional arrangements, focus offset occurs when, for instance, light-receiving means in an optical pickup device deviates in the optical axis direction. To prevent the focus offset from occurring, the adjustment is performed by moving the light-receiving means in the optical axis direction. Such an adjustment of the light-receiving means is burdensome and is hard to be precisely performed.

In view of the above, the inventors of the present application hit on an idea of preventing the focus offset from occurring, without moving the light-receiving means in the optical axis direction.

Based on this idea, as described above, the present invention is arranged in such a manner that the diffraction light passing through the diffraction element is separated into plus 1st-order diffracted light and minus 1st-order diffracted light by the first and second regions of the light-receiving element. Furthermore, these plus 1st-order diffracted light and minus 1st-order diffracted light are received by the first light-receiving means and the second light-receiving means, respectively, These first and second light-receiving means are provided on different sides of the optical axis of the light beam which is not diffracted by the diffraction element.

It is possible, for instance, that the light-receiving means each receiving a diffracted light beam may be provided on the same side of the optical axis of the optical beam which is not diffracted by the diffraction element. In this case, however, the adjustment of the focus offset cannot be done by rotating the diffraction element.

That is, in the present invention, light is diffracted after being separated into plus 1st-order diffracted light and minus 1st-order diffracted light, and the diffracted lights are received by the first and second light-receiving means, respectively. With this, when the position of the spot of the first diffracted light on the first light-receiving means rises in response to the rotation of the light-receiving element, the position of the spot of the second diffracted light on the second light-receiving means falls. On the other hand, when the position of the spot of the first diffracted light on the first light-receiving means falls, the position of the spot of the second diffracted light on the second light-receiving element rises.

In this manner, causing the position of the spot to rise or fall by a certain degree of rotation of the light-receiving element makes it possible to find a position where both the plus 1st-order diffracted light and the minus 1st-order diffracted light equally irradiate divided regions on the light-receiving means.

The focus offset does not occur when the light irradiations are equal as above. On this account, it is possible to provide the optical pickup device which allows for easy adjustment of the optical system with certainty, only by rotating the diffraction element.

It is noted that, in the specification, sets of diffracted light diffracted by the diffraction element are termed plus 1st-order diffracted light and minus 1st-order diffracted light. These terms are used only for descriptive purposes, in order to differentiate the sets of diffracted light, which are diffracted on different sides of the non-diffracted light, from each other.

In the present invention, a diffraction pitch of the first region of the diffraction element may be different from a diffraction pitch of the second region of the diffraction element.

With this arrangement, first light-receiving means that detects a light beam passing through the first region and diffracted in plus 1st order, and second light-receiving means that detects a light beam passing through the second region and diffracted in −1st order, are so positioned as not to be equidistant from the optical axis.

On this account, unnecessary diffracted light, more specifically a light beam diffracted in the first region in a minus 1st order and a light beam diffracted in the second region in a plus 1st order, does not enter the first light-receiving means and/or the second light-receiving means.

In this manner, differentiating the grating pitches of the first and second regions from each other makes it possible to prevent unnecessary diffracted light, which is emitted from the diffraction element, from entering the first light-receiving means and/or the second light-receiving means. On this account, it is possible to surely perform the adjustment of the focus offset by rotating the diffraction element around the optical axis.

In the present invention, the light-receiving element may include third light-receiving means that receives a light beam which is not diffracted by the diffraction element.

According to this arrangement, the adjustment of the positions of the diffraction element and the light-receiving means is easily carried out, and the adjustment of the focus offset is surely performed by rotating the diffraction element around the optical axis.

In the present invention, an RF signal may be detected using the light beam received by the third light-receiving means.

This arrangement makes it possible to perform high-speed playback of the RF signal. Moreover, the adjustment of the positions of the diffraction element and the light-receiving means is easily performed, and the adjustment of the focus offset is surely carried out by rotating the diffraction element around the optical axis.

In the present invention, a focus servo signal may be detected using the light beams that are received by the first light-receiving means and the second light-receiving means, respectively.

This arrangement allows for a wider positional misalignment margin of the light-receiving element.

In the present invention, the focus servo signal may be detected by a double knife edge method.

This arrangement allows for a wider positional misalignment margin of the light-receiving element.

In the present invention, a phase of a periodic structure of the first region and a phase of a periodic structure of the second region may be different from each other for 180°.

With these periodic structures, the amplitude of a push-pull signal of a sub beam is substantially 0, making it possible to cancel the offset at the time of the shifting of the objective lens or the tilting of the disk.

As described above, the optical pickup device of the present invention comprises: an objective lens that causes a light beam emitted from a light source to converge on an optical recording medium; a diffraction element that diffracts light reflected on the optical recording medium and that is divided into two or more regions; and a light-receiving element that receives a light beam diffracted by the diffraction element, the light-receiving element including: first light-receiving means that is provided so as to receive plus 1st-order diffraction light passing through a first region of said two or more regions; and second light-receiving means that is provided so as to receive minus 1st-order diffraction light passing through a second region of said two or more regions, each of the first light-receiving means and the second light-receiving means having divided regions, and the first light-receiving means and the second light-receiving means being provided on different sides of a light beam that is not diffracted by the diffraction element.

On this account, it is possible to adjust the focus offset by only rotating the diffraction element, and to manufacture the optical pickup device with ease and with certainty.

The embodiments of implementation discussed in the foregoing detailed explanation serve solely to illustrate the technical details of the present invention, which should not be narrowly interpreted within the limits of such embodiments, but rather may be applied in many variations within the spirit of the present invention, provided such variations do not exceed the scope of the patent claims set forth below.

The present invention can be suitably used for adjusting an optical system of an optical pickup device that record and/or reproduce information on/from an optical recording medium such as an optical disk.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An optical pickup device, comprising:
an objective lens that causes a light beam emitted from a light source to converge on an optical recording medium;
a diffraction element that diffracts light reflected on the optical recording medium and that is divided into two or more regions; and
a light-receiving element that receives a light beam diffracted by the diffraction element,
the light-receiving element including:
first light-receiving means that is provided so as to receive plus 1st-order diffraction light passing through a first region of said two or more regions; and
second light-receiving means that is provided so as to receive minus 1st-order diffraction light passing through a second region of said two or more regions,
each of the first light-receiving means and the second light-receiving means having divided regions, and the first light-receiving means and the second light-receiving means being provided on different sides of an optical axis of a light beam that is not diffracted by the diffraction element.

2. The optical pickup device as defined in claim 1, wherein, a diffraction pitch of the first region of the diffraction element is different from a diffraction pitch of the second region of the diffraction element.

3. The optical pickup device as defined in claim 1, wherein, the light-receiving element includes third light-receiving means that is provided so as to receive the light beam which is not diffracted by the diffraction element.

4. The optical pickup device as defined in claim 3, wherein, an RF signal is detected using the light beam received by the third light-receiving means.

5. The optical pickup device as defined in claim 1, wherein, a focus servo signal is detected using light beams received by the first light-receiving means and the second light-receiving means.

6. The optical pickup device as defined in claim 5, wherein, the focus servo signal is detected by a double knife edge method.

7. The optical pickup device as defined in claim 1, wherein, a phase of a periodic structure of the first region and a phase of a periodic structure of the second region are different from each other for 180°.
